(19) United States
(12) Patent Application Publication
(10) Pub. No.: US 2018/0019591 A1
(43) Pub. Date: Jan. 18, 2018

(54) MULTI-LAYER ELECTRIC SHOCK PROTECTION EMI FILTER DEVICE AND MANUFACTURING METHOD THEREOF

(71) Applicant: INPAQ TECHNOLOGY CO., LTD., Miaoli County (TW)

(72) Inventors: Yao-Hong CHAN, Changhua County (TW); Chin-Hung CHENG, Taichung City (TW); Wei-Cheng WU, Taichung City (TW); Chin-Chuan CHO, Taichung City (TW)

(21) Appl. No.: 15/208,833

(22) Filed: Jul. 13, 2016

(51) Int. Cl. H02H 9/04

(52) U.S. Cl. CPC H02H 9/044

(57) ABSTRACT

Disclosed is a multi-layer electric shock protection EMI filter device and a manufacturing method thereof. The multi-layer electric shock protection EMI filter device is formed by cofiring a laminated ceramic dielectric material layer, and includes: a lower capacitor, an electric shock protection device, and a upper capacitor; wherein the electric shock protection device is disposed between the lower capacitor and the upper capacitor, and isolated from the lower capacitor and the upper capacitor by a ceramic dielectric material layer, and a tripping layer is provided between two wires in the electric shock protection device, and formed by a mix of SiC and glass. After the main body is stacked and a low temperature cofire process is performed, the tripping layer becomes a compound structure of a SiC body and an air gap. Accordingly, an integrated electric shock protection EMI filter device can be manufactured to prevent electromagnetic interference, filter, and electric shock.

### BACKGROUND OF THE INVENTION

### Field of the Invention

The present invention relates to an EMI (Electromagnetic Disturbance) filer, particularly to a multi-layer electric shock protection EMI filter device which integrates a capacitor and an electric shock protection device and has optimized discharge characteristics, and a manufacturing method thereof and a manufacturing method thereof.

### Description of the Related Art

With demands of minimizing electronic components used in digital electronic devices such as mobile phones, a capacitor is developed toward a multi-layer structure. The capacity of a multi-layer ceramic capacitor is proportional to the dielectric constant of dielectric layer material constituting the capacitor or the number of the dielectric layers, and is inversely proportional to the thickness of each dielectric layer. Therefore, it is an objective of the industry to meet miniaturization demands, increase the dielectric constant of the material, and reduce the thickness of the dielectric layer, thereby increasing the number of layers.

Said electric shock protection device is provided in the area which is likely to be damaged by electric shock due to abnormal voltage electric shock (e.g. lightning surge or static electricity). When the abnormal voltage (e.g. surge) is applied, the abnormal voltage causes gas discharge and electricity consumption, which prevents electronic components on the printed circuit board from being damaged due to abnormal voltage.

Currently the capacitor and electric shock protection device are individually manufactured and provided independently. In response to more and more 3C product functions, higher frequency, and requirements for superior features, the space of components within a printed circuit board (PCB) is obviously inadequate.

In view of the problem that conventional capacitors and electric shock protection devices need to be manufactured individually and set up separately, resulting in insufficient printed circuit board space, after a long period of research in conjunction with improvement on the aforementioned deficiency, the present invention is eventually presented by the inventor.

### SUMMARY OF THE INVENTION

Accordingly, it is an objective of the present invention to provide a multi-layer electric shock protection EMI filter device and a manufacturing method thereof, which integrates a capacitor and an electric shock protection device into a single device.

According to the multi-layer electric shock protection EMI filter device and the manufacturing method thereof in the present invention, it can be implemented by integrating a capacitor and an electric shock protection device, or by integrating two capacitors and an electric shock protection device. This is a secondary objective of the present invention.

According to the multi-layer electric shock protection EMI filter device and the manufacturing method thereof in the present invention, the multi-layer electric shock protection EMI filter device is manufactured by using the ceramic green sheet as dielectric materials, stacking the dielectric material, metal layers, and an electric shock protection layer sequentially with intervals, and then performing a low temperature cofire process. This is another objective of the present invention.

According to the multi-layer electric shock protection EMI filter device and the manufacturing method thereof in the present invention, a tripping layer is provided between two metal wires on the electric shock protection device. The tripping layer is made of a mix of SiC (Silicon Carbide) and glass materials. After the low temperature cofire process, the tripping layer becomes a compound structure of a SiC body and an air gap, which achieves the effect of device integration and performance optimization. This is a further objective of the present invention.

The detailed structure, application principles, functions and effectiveness of the present invention will be apparent with reference to the following description in conjunction with the accompanying drawings.

### BRIEF DESCRIPTION OF THE DRAWINGS

FIG. 1 is an overall sectional view of a multi-layer electric shock protection EMI filter device in the present invention;

FIGS. 2A-2L are schematic plan views of manufacturing flow of the multi-layer electric shock protection EMI filter device in the present invention;

FIGS. 3A-3L are cross-sectional views relative to FIGS. 2A-2L;

FIG. 4 is a three-dimensional perspective view of the multi-layer electric shock protection EMI filter device in the present invention;

FIG. 5A is a picture showing a tripping layer of the multi-layer electric shock protection EMI filter device becomes a compound structure with any air gap after a low temperature cofire process according to the present invention;

FIG. 5B is a picture of a conventional SiC body without an air gap;

FIG. 6 shows a comparison of electrostatic discharge characteristics between the SiC body with air gap and the SiC body without air gap in the multi-layer electric shock protection EMI filter device according to the present invention;

FIG. 7 is a cross-sectional view of the multi-layer electric shock protection EMI filter device according to another embodiment of the present invention;

FIG. 8 is a cross-sectional view of the multi-layer electric shock protection EMI filter device according to another embodiment of the present invention; and

FIG. 9 is a cross-sectional view of the multi-layer electric shock protection EMI filter device according to a further embodiment of the present invention.

### DETAILED DESCRIPTION OF THE PREFERRED EMBODIMENT

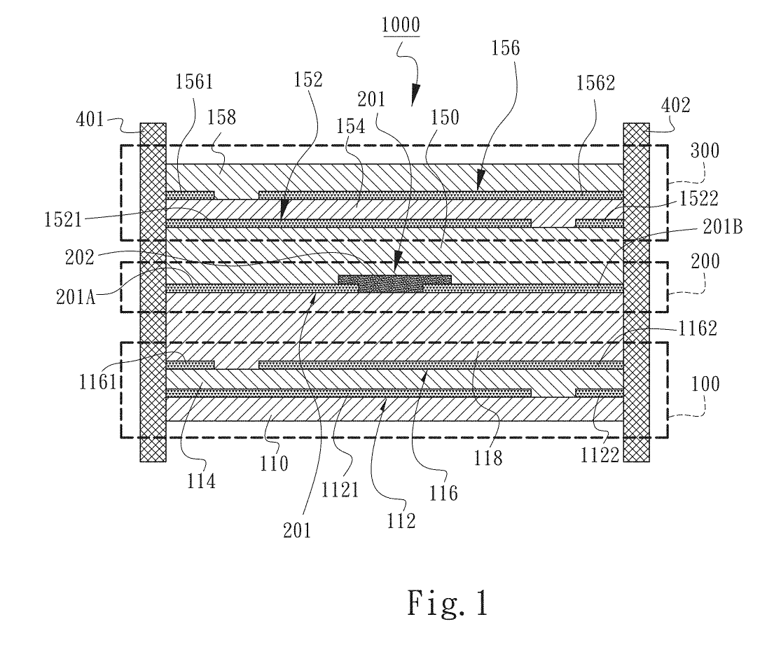

A multi-layer electric shock protection EMI filter device 1000 in the present invention, as shown in FIG. 1, includes: a lower capacitor 100, an electric shock protection device 200 and an upper capacitor 300. A first end electrode 401 and a second end electrode 402 are disposed respectively on both sides of the multi-layer electric shock protection EMI filter device 1000. Specifically, the electric shock protection device 200 is disposed between the lower capacitor 100 and the upper capacitor 300.

As shown in the figure, the multi-layer electric shock protection EMI filter device 1000 forms a first metal layer 112 on the upper surface of a first ceramic dielectric material layer 110. The first metal layer 112 includes a first metal layer A 1121 with one end connected to the first end electrode 401, and a first metal layer B 1122 with one end connected to the second end electrode 402; specifically, the opposite end of the first metal layer A 1121 is isolated from the opposite end of the first metal layer B 1122.

A second ceramic dielectric material layer 114 is formed above the first metal layer 112 to completely cover the first metal layer 112. A part of the second ceramic dielectric material layer 114 is filled up between the first metal layer A 1121 and the first metal layer B 1122.

A second metal layer 116, which is formed on the upper surface of the second ceramic dielectric material layer 114, includes a second metal layer A 1161 with one end connected to the first end electrode 401, and a second metal layer B 1162 with one end connected to the second end electrode 402; specifically, the opposite end of the second metal layer A 1161 is isolated from the opposite end of the second metal layer B 1162.

The isolated position of the second metal layer A 1161 and the second metal layer B 1162 is offset from the isolated position of the first metal layer A 1121 and the first metal layer B 1122 and is not in the same vertical line, such that the first metal layer 11.2 and the second metal layer 116 constitute the lower capacitor 100.

A third ceramic dielectric material layer 118 is formed above the second metal layer 116 to completely cover the second metal layer 116. A part of the third ceramic dielectric material layer 118 is filled up between the second metal layer A 1161 and the second metal layer B 1162.

An electric shock protection layer 201 used as the electric shock protection device 200 is formed on the upper surface of the third ceramic dielectric material layer 118, and provided with two metal wires 201A and 201B. One end of the two metal wires 201A and 201B are connected to the first end electrode 401 and the second end electrode 402 respectively. A tripping layer 202 is provided above the opposite end of the two metal wires 201A and 201B. The tripping layer 202 is a mix of SiC and glass, and is filled up between the two metal wires 201A and 201B.

A fourth ceramic dielectric material layer 150 is formed above the electric shock protection layer 201 to completely cover the electric shock protection layer 201.

A third metal layer 152, which is formed on the upper surface of the fourth ceramic dielectric material layer 150, includes a third metal layer A 1521 with one end connected to the first end electrode 401, and a third metal layer B 1522 with one end connected to the second end electrode 402; specifically, the opposite end of the third metal layer A 1521 is isolated from the opposite end of the third metal layer B 1522.

A fifth ceramic dielectric material layer 154, which is formed above the third metal layer 152 to completely cover the third metal layer 152. A part of the fifth ceramic dielectric material layer 154 is filled up between the third metal layer A 1521 and the third metal layer B 1522.

A fourth metal layer 156, which is formed on the upper surface of the fifth ceramic dielectric material layer 154, includes a fourth metal layer A 1561 with one end connected to the first end electrode 401, and a fourth metal layer B 1562 with one end connected to the second end electrode 402; specifically, the opposite end of the fourth metal layer A 1561 is isolated from the opposite end of the fourth metal layer B 1562.

A sixth ceramic dielectric material layer 158, which is formed above the fourth metal layer 156 to completely cover the fourth metal layer 156. A part of the sixth ceramic dielectric material layer 158 is filled up between the fourth metal layer A 1561 and the fourth metal layer B 1562.

The isolated position of the third metal layer A 1521 and the third metal layer B 1522 is offset from the isolated position of the fourth metal layer A 1561 and the fourth metal layer B 1562, and is not in the same vertical line, such that the third metal layer 152 and the fourth metal layer 156 constitute the upper capacitor 300.

According to the multi-layer electric shock protection EMI filter device in the present invention, the electric shock protection device 200 is disposed between the lower capacitor 100 and the upper capacitor 300. When the surge generated by electrostatic discharges, high voltage can be discharged by the electric shock protection device 200 for protecting the circuit. Also, placing the electric shock protection device 200 between the lower capacitor 100 and the upper capacitor 300 can prevent the device from bending during sintering.

Each of the aforementioned ceramic dielectric material layer 110, 114, 118, 150, 154, 158 may be made of Class I or Class II ceramic dielectric material with COG, X_R, Z_U, Y_V code. Each of metal layers 112, 116, 152, 156, 201A, 201B may be made of silver (Ag) or silver/palladium (Ag/Pd) material.

Steps of manufacturing a multi-layer electric shock protection EMI filter device according to the present invention include:

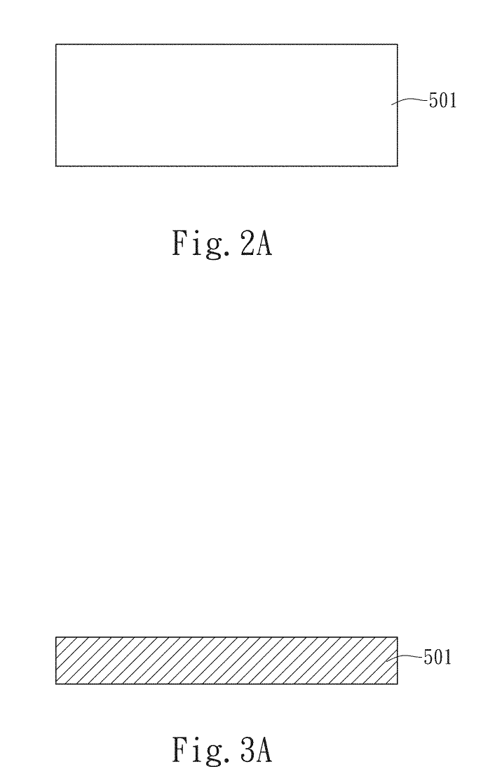

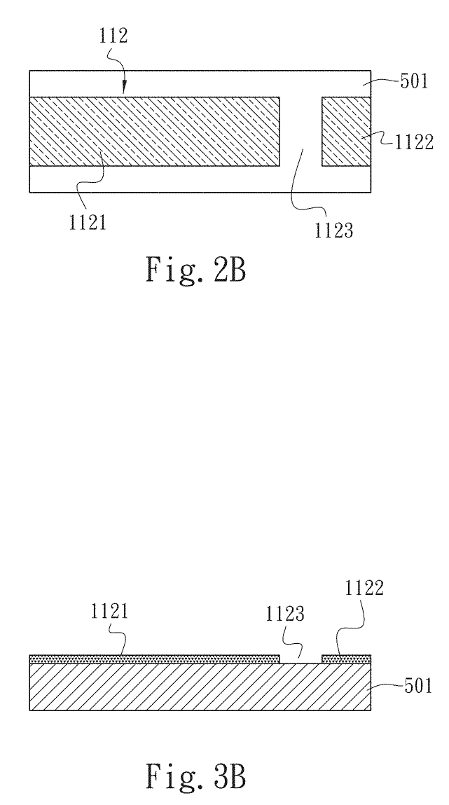

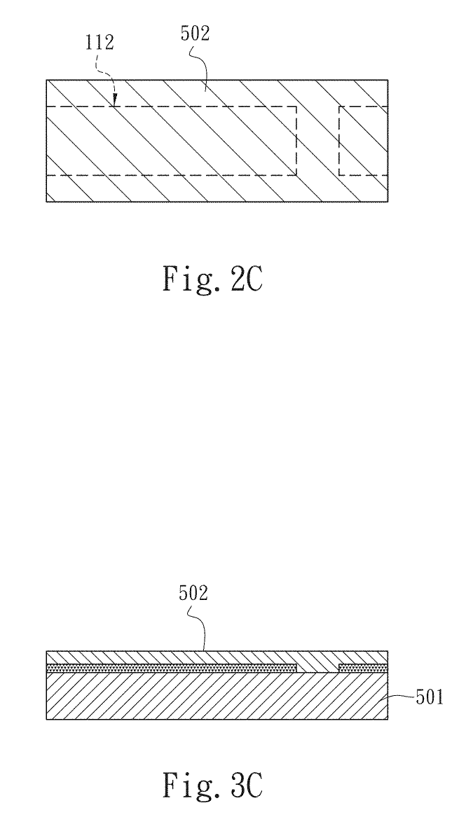

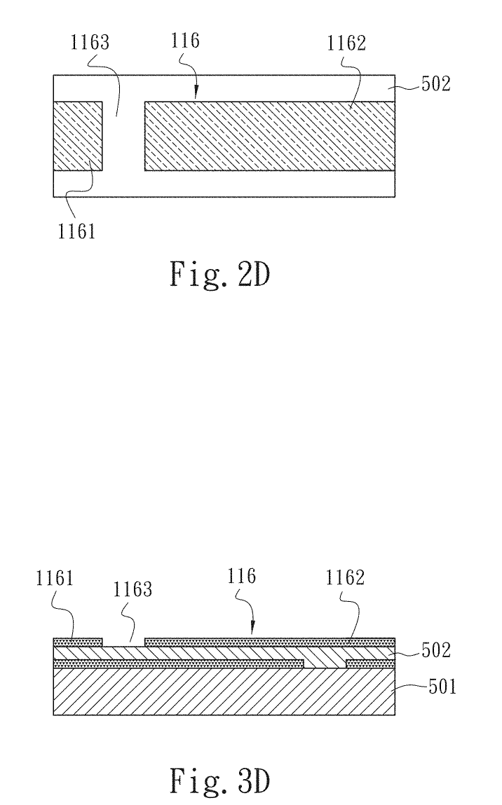

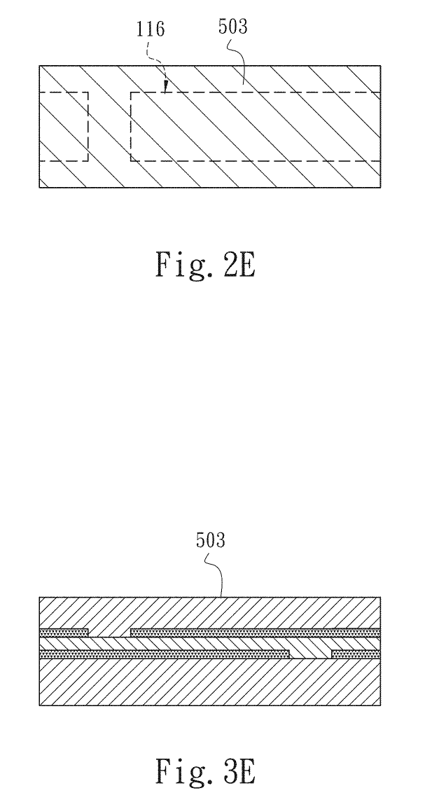

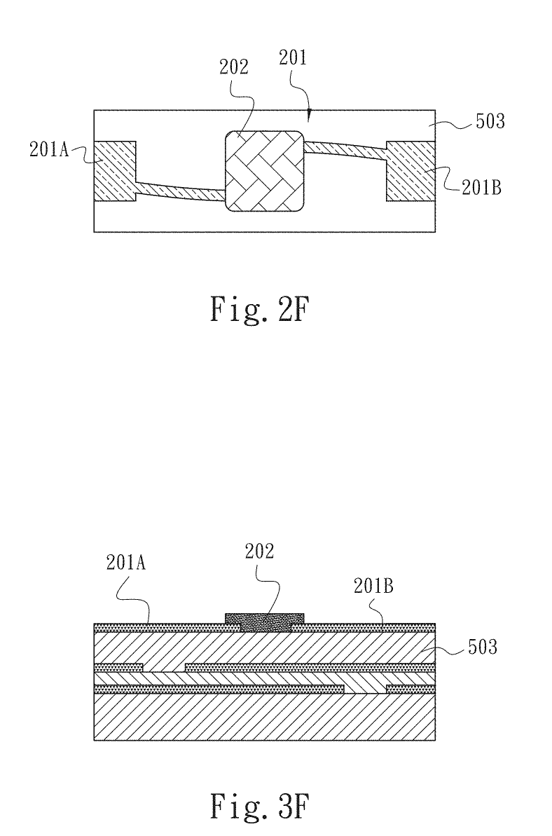

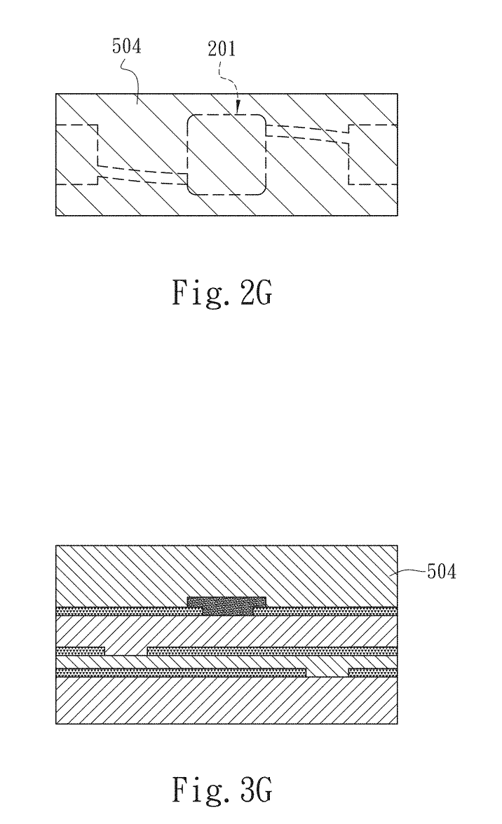

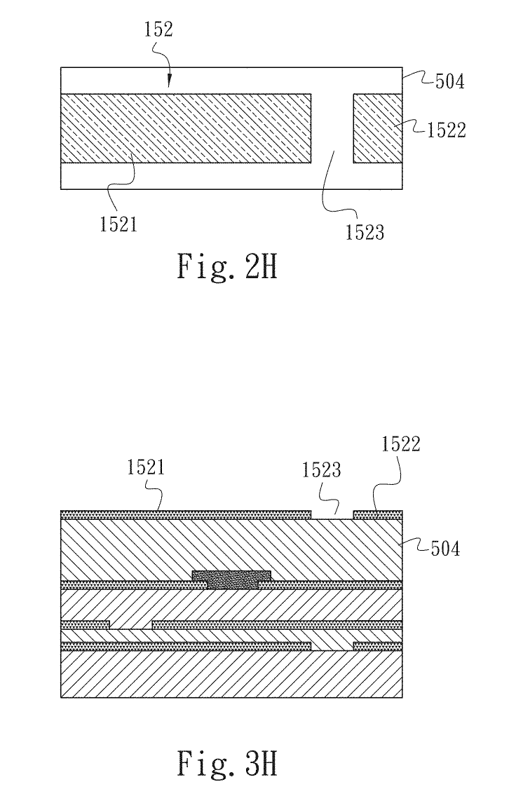

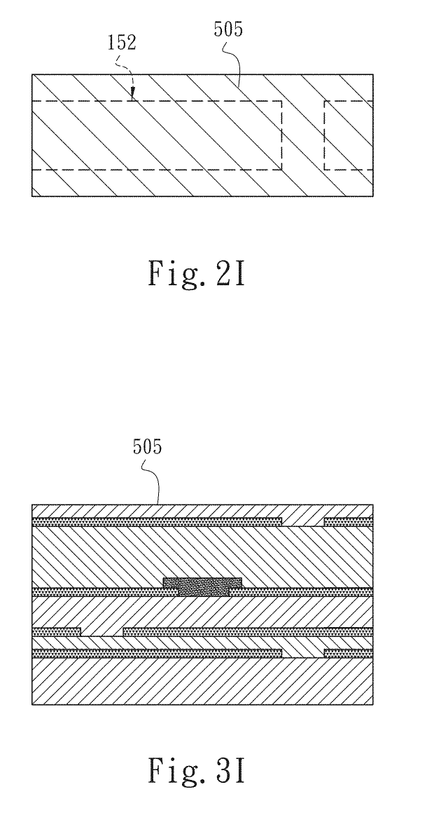

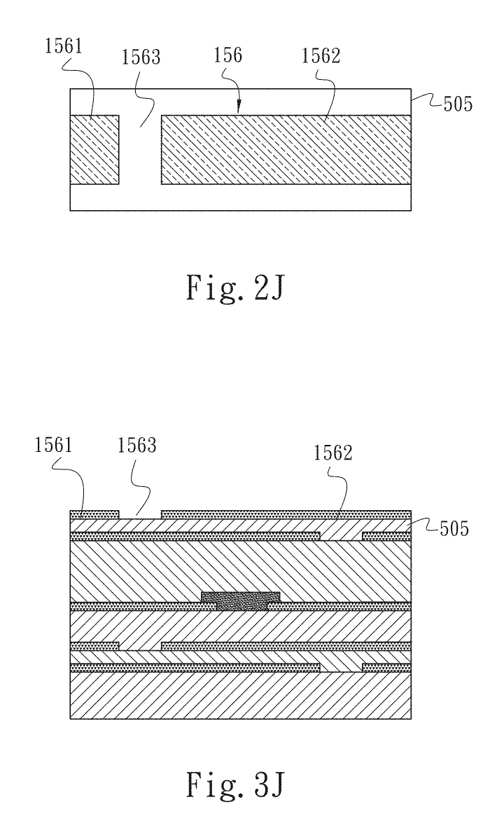

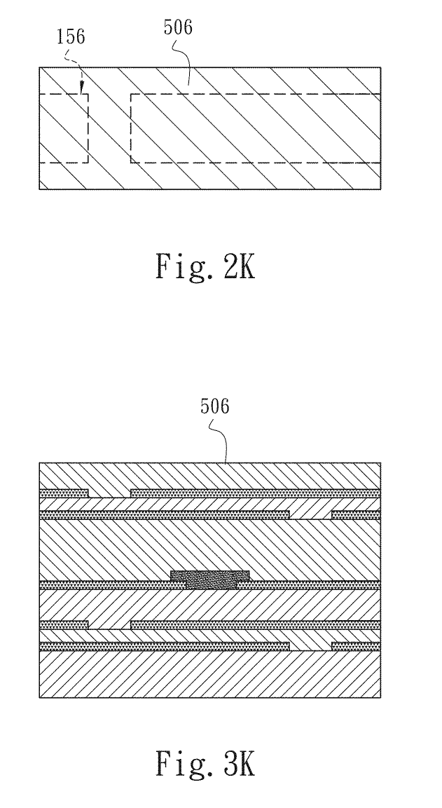

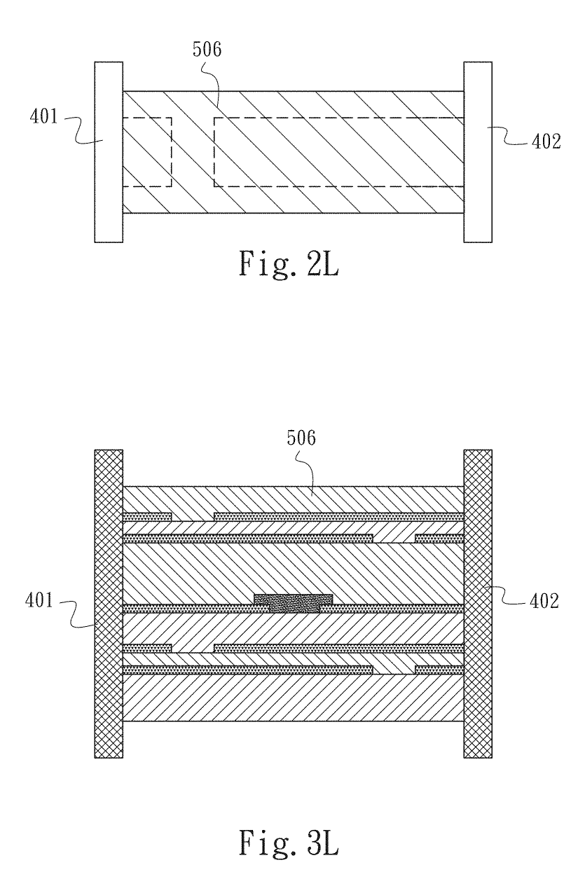

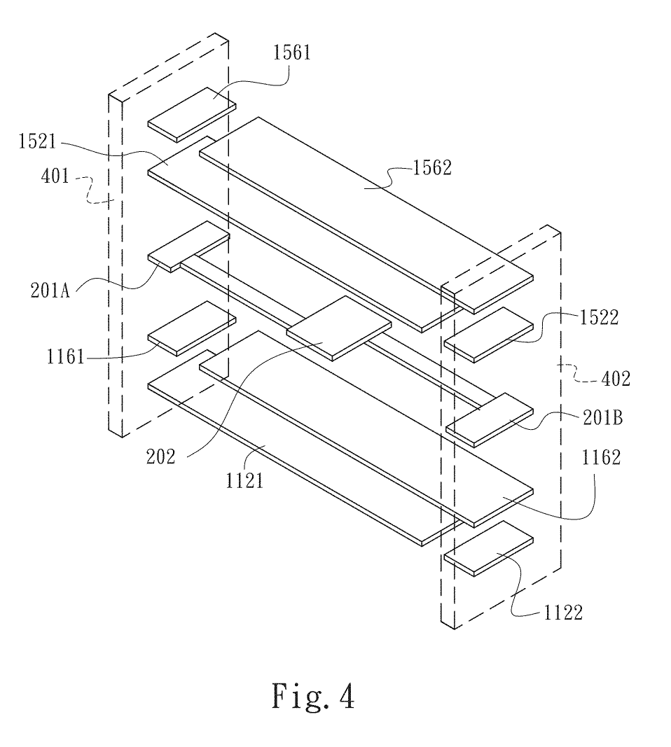

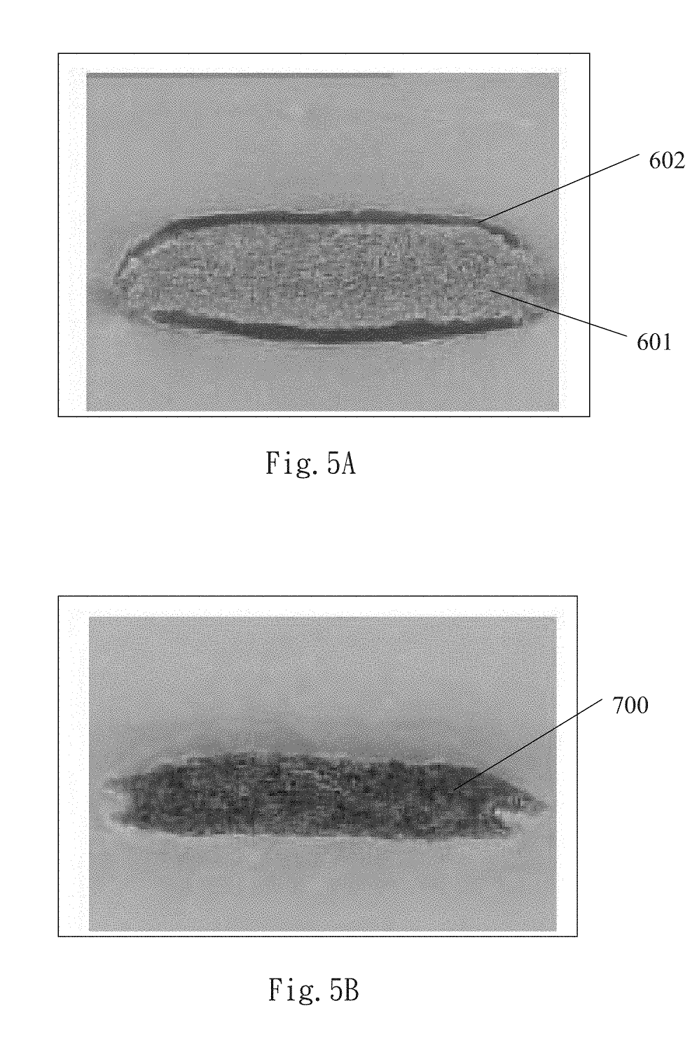

Step A: Forming a first dielectric material layer ceramic green sheet 501 (as shown in FIGS. 2A and 3A);
Step B: Printing the first metal layer 112 on the upper surface of the first dielectric material layer ceramic green sheet 501, wherein the elongated first metal layer A 112 of the first metal layer 112 and one end of the short first metal layer B 1121 are cut to be aligned with edges of the first dielectric material layer ceramic green sheet 501 respectively, and a gap 1123 is formed between the opposite end thereof (as shown in FIGS. 2B and 3B);
Step C: Providing a second dielectric material layer ceramic green sheet 502 above the first metal layer 112, and enabling the gap 1123 between the first metal layer A 1121 and the first metal layer B 1121 of the first metal layer 112 to be filled up (as shown in FIGS. 2C and 3C);
Step D: Printing the second metal layer 116 on the upper surface of the second dielectric material layer ceramic green sheet 502, wherein the short second metal layer A 1161 of the second metal layer 116 and one end of the elongated second metal layer B 1162 are cut to be aligned with edges of the second dielectric material layer ceramic green sheet 502 respectively, and a gap 1163 is formed in the opposite end thereof (as shown in FIGS. 2D and 3D);
Step E: Providing a third dielectric material layer ceramic green sheet 503 above the second metal layer 116, and enabling the gap between the second metal layer. A 1161 and the second metal layer B 1162 of the second metal layer 116 to be filled up (as shown in FIGS. 2E and 3E);
Step F: Printing the electric shock protection layer 201 on the upper surface of the third dielectric material layer ceramic green sheet 503, and enabling one end of the two metal wires 201A and 201B of the electric shock protection layer 201 to be cut and aligned with edges of the third dielectric material layer ceramic green sheet 503, and a tripping layer 202 above the opposite end thereof is a mix of SiC and glass (as shown in FIGS. 2F and 3F);
Step G: Providing a fourth dielectric material layer ceramic green sheet 504 above the electric shock protection layer 201 (as shown in FIGS. 2G and 3G);
Step H: Printing the third metal layer 152 on the upper surface of the fourth dielectric material layer ceramic green sheet 504, and enabling an elongated third metal layer A 1521 of the third metal layer 152 and one end of a short third metal layer B 1522 to be cut and aligned with edges of the fourth dielectric material layer ceramic green sheet 504 respectively, and a gap 1523 is formed in the opposite end thereof (as shown in FIGS. 2H and 3H);
Step I: Providing a fifth dielectric material layer ceramic green sheet 505 above the third metal layer 152, and enabling the gap between the third metal layer A 1521 and the third metal layer B 1522 of the third metal layer 152 to be filled up (as shown in FIGS. 2I and 3I);
Step J: Printing the fourth metal layer 156 on the upper surface of the fifth dielectric material layer ceramic green sheet 505, wherein a short fourth metal layer A 1561 of the fourth metal layer 156 and one end of an elongated fourth metal layer B 1562 are cut to be aligned with edges of the fifth dielectric material layer ceramic green sheet 505 respectively, and a gap 1563 is formed in the opposite end thereof (as shown in FIGS. 2J and 3J);
Step K. Providing a sixth dielectric material layer ceramic green sheet 506 above the fourth metal layer 156, and enabling the gap between the fourth metal layer A 1561 and the fourth metal layer B 1562 of the fourth metal layer 156 to be filled up (as shown in FIGS. 2K and 3K);
Step L: After a low temperature cofire process is performed, as shown in FIG. 5A, the tripping layer 202 of the electric shock protection layer 201, which is a mix of SiC and glass, is sintered as a compound structure of a SiC body 601 and an air gap 602. The discharge performance can be optimized by providing the tripping layer 202 with the air gap 602.
Step M: Finally, forming the first end electrode 401 and the second end electrode 402 on the overall side (as shown in FIGS. 2L, 3L and 4).

Accordingly, in the multi-layer electric shock protection EMI filter device manufactured through the above process in the present invention, after a low temperature cofire process, heterogeneous materials such as dielectric material (ceramic dielectric material layer), metal, SiC, and glass can be cofired into a whole, such that the lower capacitor 100, the electric shock protection device 200 and the upper capacitor 300 can be integrated into a whole.

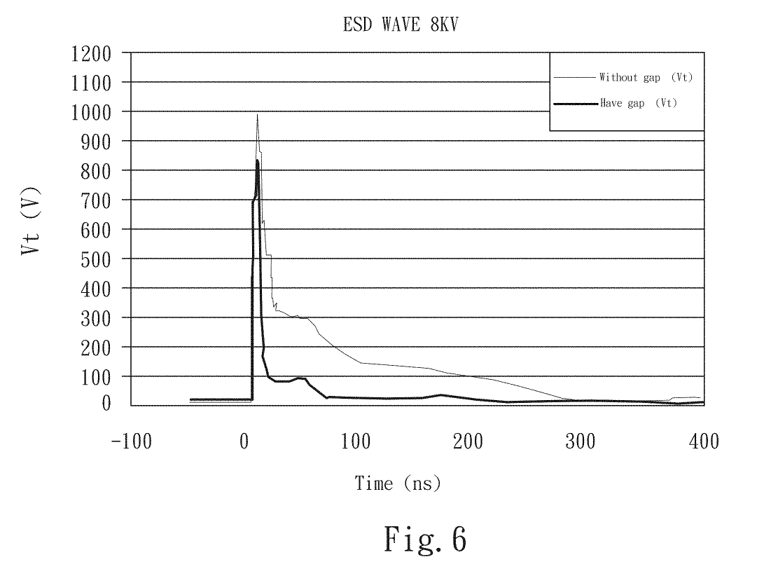

Please refer to both FIG. 5B and FIG. 6. In the multi-layer electric shock protection. EMI filter device in the present invention, as to the compound structure of the SiC body 601 and the air gap 602, compared with the SiC body 700 without any air gap as shown in FIG. 5B, according to the experiment, obviously, the tripping layer 202 having a compound structure with air gaps in the present invention has better electrostatic discharge characteristics.

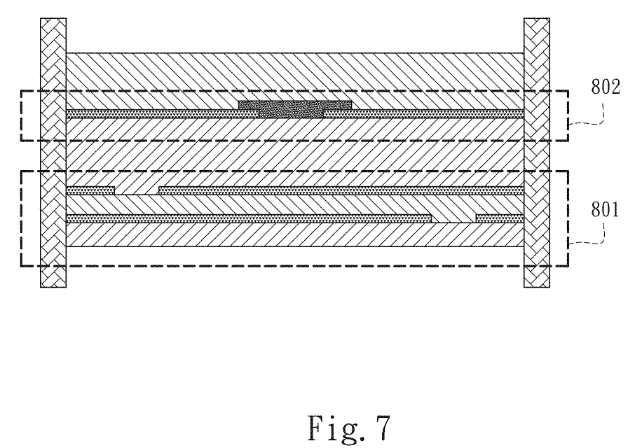

When the multi-layer electric shock protection EMI filter device in the present invention is implemented, as also shown in FIG. 7, the device body is only composed of a capacitor 801 and an electric shock protection device 802, and the capacitor 801 can be disposed on the upper or lower side of the electric shock protection device 802.

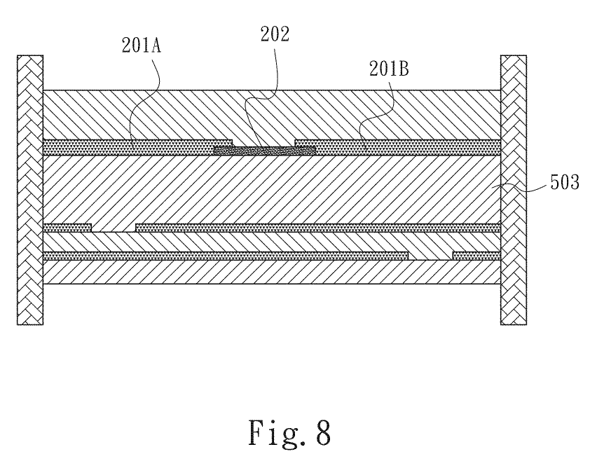

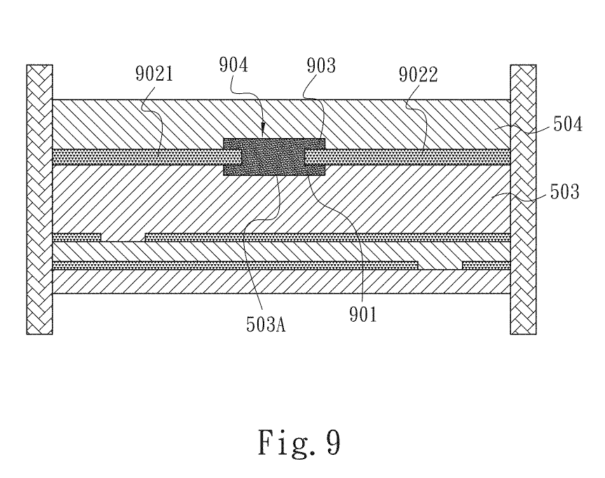

When the multi-layer electric shock protection EMI filter device in the present invention is implemented, as also shown in FIG. 8, the electric shock protection device can form the tripping layer 202 on the upper surface of the third dielectric material layer ceramic green sheet 503 after the third dielectric material layer ceramic green sheet 503 is formed, and then form metal wires 201A and 201B overlapped to the tripping layer 202 respectively at two ends of the upper surface of the third dielectric material layer ceramic green sheet 503. When the multi-layer electric shock protection EMI filter device of the present invention is implemented, as also shown in FIG. 9, when the electric shock protection device is formed on the upper surface of the third dielectric material layer ceramic green sheet 503, a groove 503A is first formed on the upper middle surface of the third dielectric material layer ceramic green sheet 503. Then, the groove 503A is filled up to form a lower body 901; next, two metal wires 9021 and 9022 are formed on the upper surface of the third dielectric material layer ceramic green sheet 503, such that one end of the two metal wires 9021 and 9022 is respectively formed on the upper surface of the lower body 901 with intervals; then, an upper body 903 is formed above the lower body 901 relatively, and an interval between two metal wires 9021 and 9022 is filled up by the upper body 903, such that the lower body 901 can be combined into one. Thereby, a tripping interlayer 904 is formed with two sides interposed between the upper end surface and lower end surface of the metal wires 9021 and 9022. Finally, forming a fourth dielectric material layer ceramic green sheet 504 is formed on the upper surface of the two metal wires 9021 and 9022 and the tripping interlayer 904.

As above, the multi-layer electric shock protection EMI filter device and a manufacturing method thereof according to the present invention can truly achieve the integration of a capacitor with an electric shock protection device and the optimization of electrostatic discharge characteristics. This is not disclosed and used in public, and is compliant with provisions of the Patent Law. It would be appreciated if the committee could kindly approve and grant a patent earlier for the benefit of society.

It should be noted that the described are preferred embodiments, and that changes and modifications may be made to the described embodiments without departing from the scope of the invention as disposed by the appended claims.

What is claimed is:

1. A multi-layer electric shock protection EMI filter device, which is formed by cofiring laminated ceramic dielectric material layers, comprising:
a capacitor, which is formed by a metal layer disposed on the top and a metal layer disposed at the bottom, wherein the two metal layers are isolated by a ceramic dielectric material layer;
an electric shock protection device, which is provided below or above the capacitor, and isolated from the capacitor by a ceramic dielectric material layer, in which a tripping layer is provided between the two metal wires; and
two terminal electrodes, which are disposed on one side of the capacitor and the electric shock protection device respectively and connected to the metal layer and one end of the metal wires.

2. The multi-layer electric shock protection EMI filter device as claimed in claim 1, wherein a capacitor may be provided above and below the electric shock protection device at the same time, and isolated from the upper and lower capacitor by the ceramic dielectric material layer.

3. The multi-layer electric shock protection EMI filter device as claimed in claim 1, wherein the tripping layer of the electric shock protection device is a compound structure of a SiC body and an air gap.

4. The multi-layer electric shock protection EMI filter device as claimed in claim 3, wherein the tripping layer of the electric shock protection device is formed between the two metal wires and disposed on the upper or lower side of the two metal wires.

5. The multi-layer electric shock protection EMI filter device as claimed in claim 3, wherein the electric shock protection device is formed between the two metal wires, and the tripping layer is a tripping interlayer with both sides thereof interposed between the upper end surface and lower end surface of the two metal wires.

6. A method for manufacturing a multi-layer electric shock protection EMI filter device, comprising steps of:
forming a first dielectric material layer ceramic green sheet;
printing a first metal layer on the upper surface of the first dielectric material layer ceramic green sheet, wherein the first metal layer includes an elongated first metal layer A and a short first metal layer B, one end of the first metal layer A and the first metal layer B are cut to be aligned with edges of the first dielectric material layer ceramic green sheet, and a gap is formed between one end and the opposite end thereof;
providing a second dielectric material layer ceramic green sheet above the first metal layer, and ensuring that the gap of the first metal layer is filled up by a part of the second dielectric material layer ceramic green sheet;
printing a second metal layer on the upper surface of the second dielectric material layer ceramic green sheet, wherein the second metal layer includes a short second metal layer A and an elongated second metal layer B, one end of the second metal layer A and the second metal layer B are cut to be aligned with edges of the second dielectric material layer ceramic green sheet, and a gap is formed between one end and the opposite end thereof;
providing a third dielectric material layer ceramic green sheet above the second metal layer, and ensuring that the gap of the second metal layer is filled up by a part of the third dielectric material layer ceramic green sheet;
printing an electric shock protection layer on the upper surface of the third dielectric material layer ceramic green sheet, wherein the electric shock protection layer is provided with two metal wires, one end of the two metal wires are cut to be aligned with edges of the third dielectric material layer ceramic green sheet respectively, and a tripping layer which is a mix of Sid; and glass is formed between one end and the opposite end thereof;
providing a fourth dielectric material layer ceramic green sheet above the electric shock protection layer;
printing a third metal layer on the upper surface of the fourth dielectric material layer ceramic green sheet, wherein the third metal layer includes an elongated third metal layer A and a short third metal layer B, one end of the third metal layer A and one end of the third metal layer B are cut to be aligned with edges of the fourth dielectric material layer ceramic green sheet respectively, and a gap is formed between one end and the opposite end thereof;
providing a fifth dielectric material layer ceramic green sheet above the third metal layer , and ensuring that the gap of the third metal layer is filled up by a part of the fifth dielectric material layer ceramic green sheet;
printing a fourth metal layer on the upper surface of the fifth dielectric material layer ceramic green sheet, wherein the fourth metal layer includes a short fourth metal layer A and an elongated fourth metal layer B, one end of the fourth metal layer A and one end of the fourth metal layer B are cut to be aligned with edges of the fifth dielectric material layer ceramic green sheet respectively, and a gap is formed between one end and the opposite end thereof;
providing a sixth dielectric material layer ceramic green sheet above the fourth metal layer, and ensuring that the gap of the fourth metal layer is filled up by a part of the sixth dielectric material layer ceramic green sheet;
then, performing a low temperature cofire process to make the overall sintered into a whole, and sintering the tripping layer of the electric shock protection layer to be a compound structure of a SiC body and an air gap; and
finally, forming a first end electrode and a second end electrode respectively on overall sides.

7. A method for manufacturing a multi-layer electric shock protection EMI filter device as claimed in claim 6, wherein the tripping layer of the electric shock protection layer is formed by a mix of SiC and glass.

8. A method for manufacturing a multi-layer electric shock protection EMI filter device as claimed in claim 6, wherein the first metal layer and the second metal layer constitute the lower capacitor, and their gaps are offset from each other and not in the same vertical line.

9. A method for manufacturing a multi-layer electric shock protection EMI filter device as claimed in claim 6, wherein the third metal layer and the fourth metal layer constitute the upper capacitor, and their gaps are offset from each other and not in the same vertical line.

10. A method for manufacturing a multi-layer electric shock protection EMI filter device as claimed in claim 6, wherein the ceramic dielectric material layer may be made of Class I or Class II ceramic dielectric material with COG, X_R, L_U, Y_V code, and each of the metal layers may be made of silver (Ag) or silver/palladium (Ag/Pd) material.

11. A method for manufacturing a multi-layer electric shock protection EMI filter device as claimed in claim 6, wherein the tripping layer of the electric shock protection layer may be formed on the upper or lower side of the two metal wires.

12. A method for manufacturing a multi-layer electric shock protection EMI filter device as claimed in claim 6, wherein the tripping layer of the electric shock protection layer may be a tripping interlayer with both sides thereof interposed between the upper end surface and lower end surface of the two metal wires.
